(19) United States
(12) Patent Application Publication
(10) Pub. No.: US 2010/0015463 A1
(43) Pub. Date: Jan. 21, 2010

(54) THREE-PART METALLURGY SYSTEM INCLUDING ALUMINUM AND TITANIUM FOR LIGHTWEIGHT ALLOY

(76) Inventor: June Sang Siak, Troy, MI (US)

Correspondence Address: REISING ETHINGTON P.C., P O BOX 4390, TROY, MI, 48099-4390, US

(21) Appl. No.: 12/518,431

(22) PCT Filed: Dec. 21, 2007
(86) PCT No.: PCT/US2007/088515

§ 371 Date: Jun. 10, 2009

Related U.S. Application Data
(60) Provisional application No. 60/871,790, filed on Dec. 23, 2006.

(51) Int. Cl. B32B 15/02; B22F 1/00; B22F 3/10; B22F 7/00; B23K 31/02

(52) U.S. Cl. 428/558; 75/228; 419/1; 419/57; 419/5; 228/198

(57) ABSTRACT

One embodiment of the invention includes first particles comprising an intermetallic compound comprising titanium and aluminum; second particles comprising aluminum; and third particles comprising titanium.

### CROSS REFERENCE TO RELATED APPLICATIONS

This application claims the benefit of U.S. Provisional Application No. 60/871,790, filed Dec. 23, 2006.

### TECHNICAL FIELD

The field to which the disclosure generally relates includes lightweight high temperature alloys and methods of making the same.

### BACKGROUND

Aluminum has many advantages because of its light weight and low cost. However, it has limitations in high temperature applications.

### SUMMARY OF EXEMPLARY EMBODIMENTS OF THE INVENTION

One embodiment of the invention includes first particles comprising an intermetallic compound comprising titanium and aluminum; second particles comprising aluminum or aluminum alloy with lower Ti containment than first particle; and third particles comprising titanium.

Other exemplary embodiments of the invention will become apparent from the detailed description of exemplary embodiments provided hereinafter. It should be understood that the detailed description and specific examples, while indicating the exemplary embodiments of the invention, are intended for purposes of illustration only and are not intended to limit the scope of the invention.

### BRIEF DESCRIPTION OF THE DRAWINGS

Exemplary embodiments of the invention will become more fully understood from the detailed description and the accompanying drawings, wherein:

FIG. 1 is a graph of displacement (μm) versus temperature (degrees C.) of three samples after hot isostatic pressing (HIP) containing 99 wt. % Al and 1 wt. % Ti; 97.5 wt. % Al and 2.5 wt. % Ti; and 95 wt. % Al and 5 wt. % Ti;

FIG. 2 is a graph of heat flow (mW) versus temperature (degrees C.) of a sample containing 28.5 wt. % Al, 70 wt. % AlTi, and 1.5 wt. % Ti during hot isostatic pressing (HIP) and after HIP; and

FIG. 3 shows an electron image of a sample containing 7.15 wt. % O, 90.98 wt. % Al, and 1.87 wt. % Ti.

### DETAILED DESCRIPTION OF EXEMPLARY EMBODIMENTS

The following description of the embodiments is merely exemplary in nature and is in no way intended to limit the invention, its application, or uses.

According to one embodiment of the invention, a product includes a powder including three components. The product may include first particles comprising an intermetallic compound comprising titanium and aluminum; second particles comprising aluminum; and third particles comprising titanium.

In one embodiment the first particles may be present in about 60 weight percent (wt. %) to about 80 wt. %, the second particles may be present in about 19 wt. % to about 38 wt. % and the third particles may be present in about 0.5 wt. % to 20 wt. %. The first particles may be 40 to 150 microns. The second particles may be 20 to 40 microns. In one embodiment, the second particles comprise aluminum and titanium. In another embodiment, the third particles may be 1 to 5 microns. The aluminum used in the first particles and second particles may also be an aluminum alloy (Cu, Si, etc). For example, the second particles may include aluminum 6061 and the first particles may include TiAl₃ produced using Aluminum 6061. For example, the Aluminum 6061 may include Chromium at 0.04-0.35 wt. %, Copper at 0.15-0.4 wt. %, Iron at 0-0.7 wt. %, Magnesium at 0.8-1.2 wt. %, Manganese up to 0.15 wt. %, Silicon at 0.4-0.8 wt. %, Titanium up to 0.15 wt. %, Zinc up to 0.25 wt. %, impurities up to 1 wt. %, with the balance aluminum.

The stiff phase transition curve of aluminum-titanium alloy from one weight percent titanium to twenty weight percent titanium can be used to form a light weight high temperature metal structure with powder metal. For example, an aluminum-titanium alloy containing one weight percent titanium would melt at approximately 890° C. An aluminum-titanium alloy containing five weight percent titanium would melt at approximately 1080° C. Aluminum alloys usually melt at approximately 600° C. Pure titanium will dissolve into molten aluminum although it has a melting temperature higher than 1720° C. which is due to an exothermic reaction of titanium in molten aluminum.

Powder metal sintering and densification usually results in some shrinkage and porosity in the structure. Aluminum powder sintering is difficult because the oxide layer on the outside of the aluminum particle is hard to pelt at sintering temperature.

In one embodiment, the product can be sintered to tack the first particles together with a brazing material. The brazing juncture alloy may have a higher melting point than the first particles. The first particles have a higher melting point than the second particles. The second particles may serve as the solution metal during sintering to braze the high melting point first particles. The brazing material may include aluminum or aluminum-titanium. The ratio of the first particles to the second particles may be sixty percent to forty percent.

In one embodiment, the third particles are added to the second particles (the low melting Al/Ti portion) to reach a 5% Ti content when this portion is in solution. For example, 0.9 g of the third particles would be added to 30 g of the second particles (2%) which will reach a 5% Ti content when this portion is melted during sintering.

The form may be prepared by hot press or cold press with or without binder. Sintering may be performed in a sintering furnace with forming gas or hot isostatic pressing or by immersion in a molten metal or molten salt bath. In one embodiment, the sintering temperature may be 150° C. lower than the melting point of the first particles.

In one embodiment, a feeder structure is added to the form which contains pressed second particles and third particles. The feeder structure may be used to add the second and third particles to penetrate voids between first particles. The ratio of the first particles to the second particles may be sixty percent to forty percent. During sintering the structure may melt and feed the form to reduce porosity.

According to one embodiment of the method disclosed, the sintering of the first, second and third particles occurs at 785° C. for 120 minutes, resulting in no crust formation but with loose structure. In another embodiment, the sintering occurs at 785° C. for 300 minutes, resulting in no crust formation and a strong structure either with or without titanium powder. In another embodiment, the sintering occurs at 870° C. for 180 minutes without titanium powder, resulting in no crust formation and a strong structure. In another embodiment, the sintering occurs at 870° C. for 180 minutes with titanium powder, resulting in no crust formation, a strong structure, and easy machining. In another embodiment, the sintering occurs at 980° C. for 120 minutes without titanium powder, resulting in no crust formation and a strong structure. In another embodiment, the sintering occurs at 980° C. for 120 minutes with titanium powder, resulting in no crust formation, a strong structure, and easy machining. In another embodiment, the sintering occurs at 1145° C. for 60 minutes without titanium powder, resulting in a melting of TiAl₃ and inclusion of proppants in the structure which may be removed by machining. In another embodiment of the invention first particles comprising an intermetallic compound of aluminum and titanium, second particles comprising aluminum and third particles comprising titanium are printed, and sintered using stereolithography techniques to make a porous structure.

Various embodiments of the invention may include the loose pack sintering of a powder metallurgy system with the total weight of 10 grams, including 9 grams of the first particles, 1 gram of the second particles, and 0.5 gram of the third particles. The resultant sintered product was covered with proppants. The sintering conditions include using forming gas comprising 95% argon and 5% hydrogen at 825-860 torr. The temperature ramping scheme includes an initial ramp to 675° C. at 10° C./minute, followed by a ramp to the final temperature at 5° C./minute. The hold times include 120 minutes or 300 minutes at 785° C., 180 minutes at 870° C., 120 minutes at 980° C., and 60 minutes at 1145° C.

The aluminum-titanium solution should be retained by capillary function of structure. The sintered product may be used in a variety of applications including, but not limited to, exhaust manifold and combustion engine piston cylinder liners, particularly for aluminum engines.

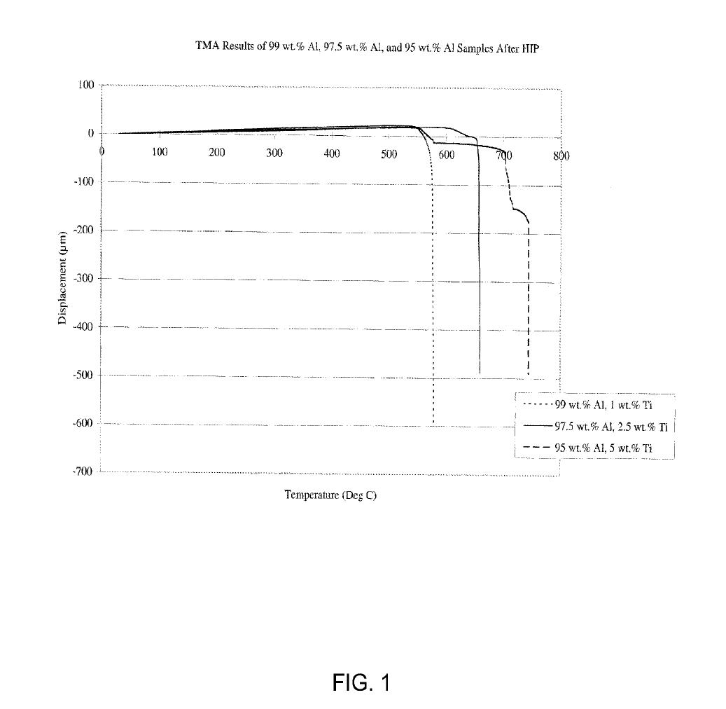

FIG. 1 is a graph of thermomechanical analysis (TMA) results. TMA may include the use of a thermomechanical analyzer to measure dimensional and viscoelastic changes as a function of temperature or time. FIG. 1 shows displacement (μm) versus temperature (degrees C.) for three different samples after hot isostatic pressing (HIP). The HIP process may subject a sample to high temperature and pressure simultaneously and from many different directions. The first sample contains 99 wt. % Al and 1 wt. % Ti. The second sample contains 97.5 wt. % Al and 2.5 wt. % Ti. The third sample contains 95 wt. % Al and 5 wt. % Ti.

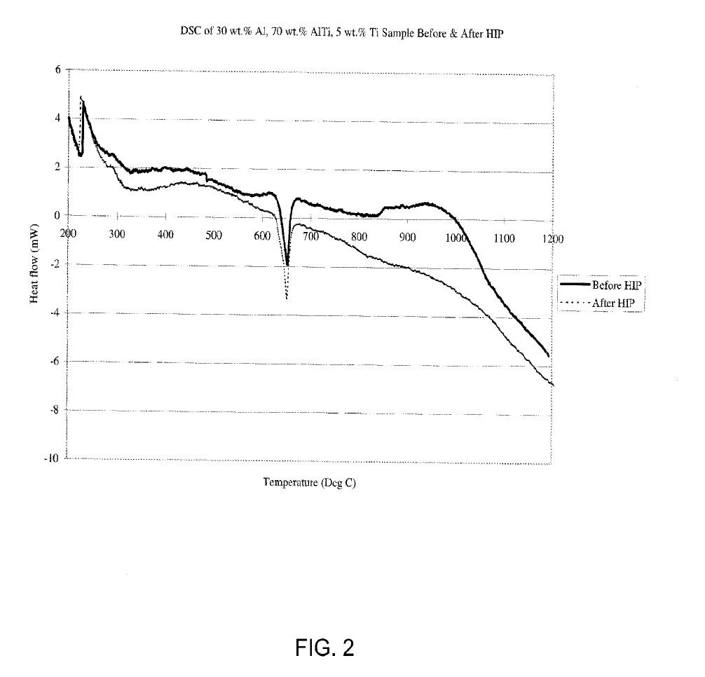

FIG. 2 is a graph of differential scanning calorimetry (DSC) results. DSC may include the use of a differential scanning calorimeter to measure the amount of energy (heat) absorbed or released by a sample as it is heated, cooled, or held at a constant temperature. FIG. 2 shows heat flow (mW) versus temperature (degrees C.) of a sample containing 28.5 wt. % Al, 70 wt. % AlTi, and 1.5 wt. % Ti before HIP and after HIP. In FIG. 2, there is a peak between 700 and 1000 during HIP, and the peak is absent after HIP indicating an exothermic reaction of the aluminum solution with Ti.

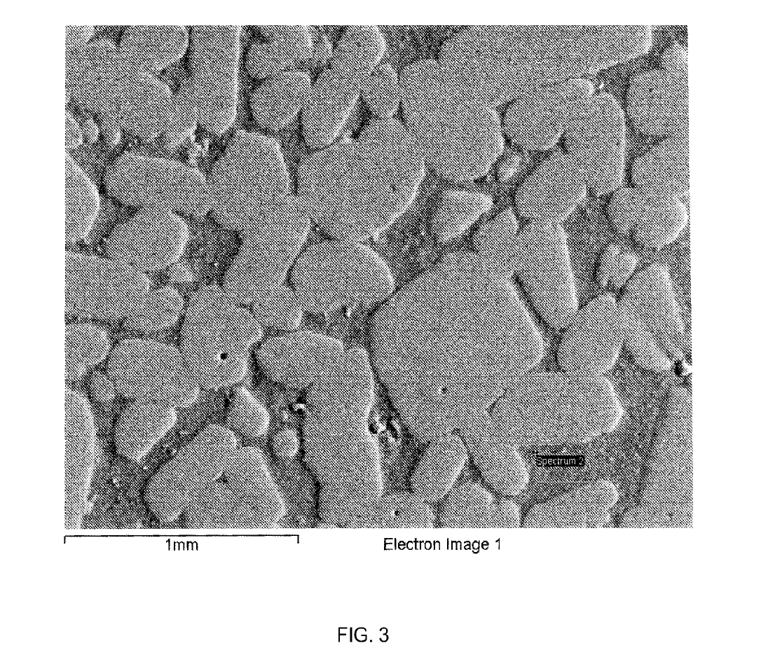

FIG. 3 shows an electron image of a sample containing 7.15 wt. % aluminum oxide and titanimoxide, 90.98 wt. % Al, and 1.87 wt. % Ti. FIG. 3 shows the boundary between brazing matrix and the first particle show good bonding.

The above description of embodiments of the invention is merely exemplary in nature and, thus, variations thereof are not to be regarded as a departure from the spirit and scope of the invention.

What is claimed is:

1. A powder metallurgy product comprising:
first particles comprising an intermetallic compound comprising titanium and aluminum;
second particles comprising aluminum; and
third particles comprising titanium.

2. A product as set forth in claim 1 wherein the first particles have an average particle size range of about 40 to 150 microns.

3. A product as set forth in claim 1 wherein the second particles have an average particle size range of about 20 to 40 microns.

4. A product as set forth in claim 1 wherein the third particles have an average particle size range of about 1 to 5 microns.

5. A product as set forth in claim 1 wherein the intermetallic compound comprises AlTi₃.

6. A product as set forth in claim 1 wherein the second particles comprise at least one of aluminum or an aluminum alloy and titanium.

7. A product as set forth in claim 1 wherein the second particles have a lower melting point than the first particles.

8. A product as set forth in claim 1 wherein the first particles are present in about 60 to about 80 weight percent, the second particles are present in about 19 to about 38 weight percent, and the third particles are present in about 0.5 to about 20 weight percent of the total powder metallurgy product.

9. A sintered product comprising:
first particles comprising an intermetallic compound comprising titanium and aluminum; and
a brazing material brazing the first particles together.

10. A product as set forth in claim 9 wherein the brazing material comprises titanium.

11. A product as set forth in claim 9 wherein the brazing material comprises aluminum.

12. A product as set forth in claim 9 wherein the brazing material comprises an aluminum-titanium compound.

13. A product as set forth in claim 9 wherein the first particles comprise AlTi₃ or an aluminum and titanium alloy with a different atomic percentage than AlTi₃.

14. A process comprising:
providing a powder metallurgy product comprising first particles comprising an intermetallic compound comprising titanium and aluminum, second particles comprising aluminum or aluminum titanium alloy with lower Ti content than first particle, and third particles comprising titanium; and
sintering the first particles, second particles, and third particles to form a sintered product comprising the first particles and a brazing material connecting the first particles to each other.

15. A process as set forth in claim 14 wherein the sintering is performed at a temperature higher than the melting point of the second particles for a time sufficient to result in good bonding between the brazing material and the first particles.

16. A process as set forth in claim 15 wherein the sintering is performed in a sintering furnace with forming gas comprising 95% argon and 5% hydrogen at 825-860 torr.

17. A process as set forth in claim 14 wherein the first particles comprise AlTi₃.

18. A process as set forth in claim wherein the brazing material comprises aluminum.

19. A process as set forth in claim 14 wherein the brazing material comprises an aluminum-titanium compound.

20. A process as set forth in claim 14 wherein the first particles are present in about 60 to about 80 weight percent, the second particles are present in about 19 to about 38 weight percent, and the third particles are present in about 0.5 to about 20 weight percent of the total powder metallurgy product.

21. A process as set forth in claim 15 wherein the sintering is performed at a temperature of about 100° C.

22. A process comprising:
printing a mixture comprising first particles comprising an intermetallic compound of aluminum and titanium, second particles comprising aluminum and third particles comprising titanium and sintered the printed mixture using stereolithography techniques.

23. A process as set forth in claim 14 wherein the sintering comprises immersing the powder metallurgy product in molten metal or a molten salt bath.

24. A process comprising:
sterolithogrically depositing and sintering a plurality of layers each comprising a powder metallurgy comprising first particles comprising an intermetallic compound comprising titanium and aluminum, second particles comprising aluminum or aluminum titanium alloy with lower Ti content than the first particle to produce a product, the first particles and a brazing material connecting the first particles together.

25. A process comprising:
providing a metallurgy product comprising first particles comprising an intermetallic compound comprising titanium and aluminum, second particle comprising aluminum or aluminum titanium alloy with lower Ti content than the first particles, and third particles comprising titanium, causing the second particles to form a solution and exothermically react with the third particles and forming a product comprising the first particles and a brazing material connecting the first particles to each other.
